(19) United States
(12) Patent Application Publication
(10) Pub. No.: US 2018/0060016 A1
(43) Pub. Date: Mar. 1, 2018

(54) DISPLAY CONTROL APPARATUS AND NON-TRANSITORY COMPUTER-READABLE RECORDING MEDIUM WITH DATA TRANSMISSION PROGRAM RECORDED THEREON

(71) Applicant: KYOCERA Document Solutions Inc., Osaka (JP)

(72) Inventor: Isao KODA, Osaka (JP)

(73) Assignee: KYOCERA Document Solutions Inc., Osaka (JP)

(21) Appl. No.: 15/672,678

(22) Filed: Aug. 9, 2017

(30) Foreign Application Priority Data
Aug. 23, 2016 (JP) 2016-163012

(51) Int. Cl. G06F 3/14; G09G 5/14; G06F 3/0484; G06F 21/62

(52) U.S. Cl. CPC G06F 3/1454; G09G 5/14; H04N 1/00411; G06F 21/6245; G09G 2358/00; G06F 3/04845

(57) ABSTRACT

A display control apparatus includes: an operation acceptance section that accepts a user's input of an operation; a screen data storage section that stores a plurality of sets of screen data on respective display screens for being displayed; a display control section that allows display of the plurality of sets of screen data as the respective display screens while providing a transition from one display screen to another; a hiding section that, when the operation acceptance section accepts a specification of an area in the display screen, manipulates screen data present within the specified area to hide the area; and a transmission control section that measures a time elapsed since the transition, and, upon passage of a predetermined set time since the transition, provides transmission of the set of screen data or, when the area is hidden, the set of screen data containing the hidden area to an external terminal.

### INCORPORATION BY REFERENCE

This application claims priority to Japanese Patent Application No. 2016-163012 filed on 23 Aug. 2016, the entire disclosure of which are incorporated herein by reference.

### BACKGROUND

The present disclosure relates to display control apparatuses and non-transitory computer-readable recording media with a data transmission program recorded thereon and particularly relates to a technique for hiding a user-specified area in a display screen on a user's apparatus when sharing the display screen with an external terminal.

There is a system in which a screen is shared via a computer network among a plurality of terminals. For example, a technique is known in which a terminal to be monitored sends screen data on a display screen being displayed on the terminal to an external terminal and the external terminal reproduces the display screen based on the screen data sent from the terminal to be monitored. With the use of this technique, a display screen being displayed on a malfunctioning electronic apparatus can be shared with an operator's terminal in a remote location, which provides, for example, the effect of enabling more efficient maintenance.

However, a display screen displayed on such an electronic apparatus may contain information to be kept secret, such as personal information. For this reason, there is proposed an invention for preventing sharing of confidential information. For example, for a general electronic apparatus, a technique is proposed in which a user previously sets conditions of information to be hidden and information (confidential information) meeting the conditions is hidden.

### SUMMARY

A technique improved over the aforementioned technique is proposed as one aspect of the present disclosure.

A display control apparatus according to an aspect of the present disclosure includes a display section, an operation acceptance section, a screen data storage section, a display control section, a hiding section, and a transmission control section. The operation acceptance section accepts a user's input of an operation. The screen data storage section stores a plurality of sets of screen data on respective display screens to be displayed on the display section. The display control section allows the display section to display the plurality of sets of screen data as the respective display screens, the plurality of sets of screen data being stored in the screen data storage section, while the display control section provides a transition from one of the display screens to another. When the operation acceptance section accepts a specification of an area in one of the display screens, the hiding section manipulates the screen data present within the area to hide the area. The transmission control section measures a time elapsed from a point of time when the display control section has provided the transition from the one display screen to the another, and, upon passage of a predetermined set time since the display control section has provided the transition from the one display screen to the another, provides transmission of the set of screen data or, when the hiding section has manipulated the screen data present within the area, the set of screen data containing the manipulated screen data to an external terminal.

Furthermore, another aspect of the present disclosure is a non-transitory computer-readable recording medium with a data transmission program recorded thereon. The data transmission program allows a computer to function as: an operation acceptance section that accepts a user's input of an operation; a screen data storage section that stores a plurality of sets of screen data on respective display screens to be displayed on a display section; a display control section that allows the display section to display the plurality of sets of screen data as the respective display screens, the plurality of sets of screen data being stored in the screen data storage section, while providing a transition from one of the display screens to another; a hiding section that, when the operation acceptance section accepts a specification of an area in one of the display screens, manipulates the screen data present within the area to hide the area; and a transmission control section that measures a time elapsed from a point of time when the display control section has provided the transition from the one display screen to the another, and, upon passage of a predetermined set time since the display control section has provided the transition from the one display screen to the another, provides transmission of the set of screen data or, when the hiding section has manipulated the screen data present within the area, the set of screen data containing the manipulated screen data to an external terminal.

### BRIEF DESCRIPTION OF THE DRAWINGS

FIG. 1 is a functional block diagram schematically showing an essential internal configuration of an image forming apparatus serving as a display control apparatus according to a first embodiment of the present disclosure.

FIG. 2 is a flowchart showing a first embodiment of processing for sending screen data performed by the image forming apparatus.

FIGS. 3A, 3B, and 3C are explanatory views for illustrating a flow of manipulation of screen data present within an area specified by a user.

FIG. 4 is an explanatory diagram for illustrating a flow of transition between screens in the image forming apparatus and a flow of transition between screens in an external apparatus.

FIG. 5 is a flowchart showing a second embodiment of processing for sending screen data performed by the image forming apparatus.

FIG. 6 is an explanatory diagram for illustrating a flow of transition between screens in the image forming apparatus and a flow of transition between screens in an external apparatus.

### DETAILED DESCRIPTION

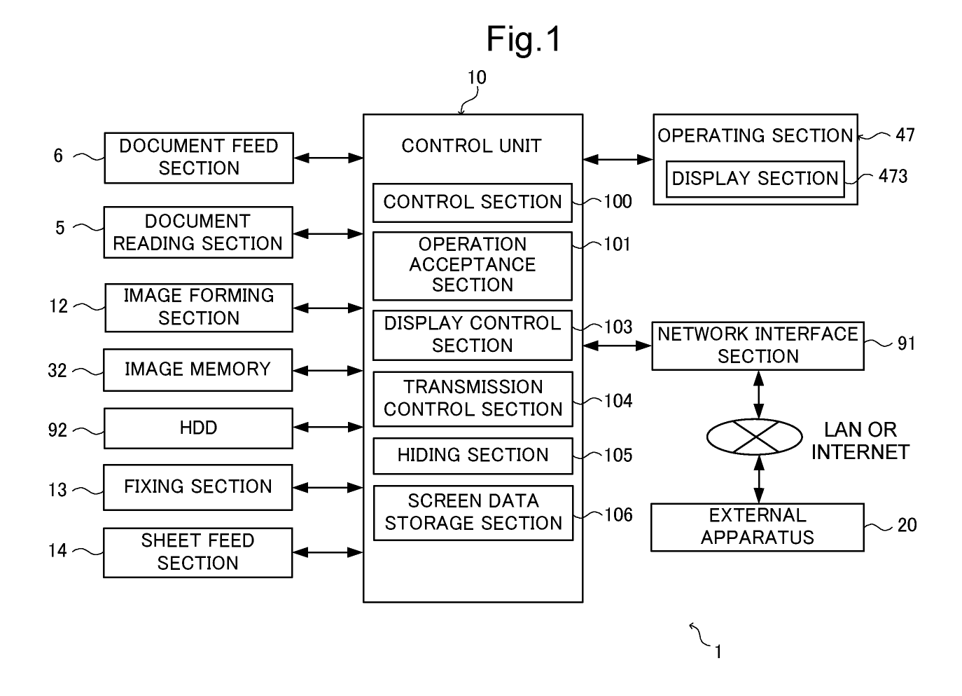

Hereinafter, a description will be given of embodiments of a display control apparatus and a data transmission program both according to the present disclosure with reference to the drawings. FIG. 1 is a functional block diagram schematically showing an essential internal configuration of an image forming apparatus serving as a display control apparatus according to a first embodiment of the present disclosure. The image forming apparatus 1 is a multifunction peripheral having multiple functions including, for example, a copy function, a print function, a scan function, and a facsimile function and is made up by including a control unit 10, a document feed section 6, a document reading section 5, an image forming section 12, an image memory 32, an HDD (hard disk drive) 92, a fixing section 13, a sheet feed section 14, an operating section 47, and a network interface section 91.

The document feed section 6 feeds an original document to be read to the document reading section 5. The document reading section 5 reads, under control of a control section 100 constituting an element of a control unit 10, a document image from the original document by irradiating the original document with light using a lighting part and receiving the reflected light. Image data acquired by reading of the original document by the document reading section 5 is stored in the image memory 32.

The image forming section 12 forms on a sheet (recording medium) a toner image of an image to be printed. The image memory 32 provides a region for temporarily storing image data of the original document acquired by reading by the document reading section 5 and temporarily saving data to be printed by the image forming section 12.

The HDD 92 is a large storage device capable of storing document images and so on acquired by the document reading section 5. The fixing section 13 fixes the toner image on the sheet by the application of heat and pressure. The sheet feed section 14 includes a sheet feed cassette (not shown), picks up sheets contained in the sheet feed cassette, and conveys the sheets.

The operating section 47 accepts operator's instructions for various types of operations and processing executable by the image forming apparatus 1, such as an instruction to perform an image forming operation and an instruction to perform a document reading operation. The operating section 47 includes a display section 473 that displays operation guidance and so on for the operator. The display section 473 is formed of a touch panel. The operator can operate the image forming apparatus 1 with the touch of buttons and keys displayed on a screen.

The network interface section 91 transfers various data to and from external apparatuses 20, such as personal computers, in a local area or on the Internet.

The control unit 10 is made up by including a processor, a RAM (random access memory), a ROM (read only memory), and a dedicated hardware circuit. The processor is, for example, a CPU (central processing unit), an ASIC or an MPU. The control unit 10 includes the control section 100 governing the overall operation control of the image forming apparatus 1, an operation acceptance section 101, a display control section 103, a transmission control section 104, a hiding section 105, and a screen data storage section 106.

The control unit 10 functions as the control section 100, the operation acceptance section 101, the display control section 103, the transmission control section 104, the hiding section 105, and the screen data storage section 106 by operating in accordance with a data transmission program installed on the HDD 92. However, each of the above-mentioned control section 100 and other sections may not be implemented by the operation of the control unit 10 in accordance with the data transmission program but may be constituted by a hardware circuit. Hereinafter, the same applies to the other embodiments unless otherwise stated.

The control section 100 is connected to the document feed section 6, the document reading section 5, the image forming section 12, the image memory 32, the HDD 92, the fixing section 13, the sheet feed section 14, the operating section 47, and the network interface section 91 and controls the operations of these components.

The operation acceptance section 101 identifies a user's operation input by a user, based on a detection signal output from the operating section 47. Then, the operation acceptance section 101 accepts the identified user's operation and outputs a control signal indicating the user's operation to the control section 100 and so on.

The display control section 103 controls a display operation of the display section 473. The display control section 103 allows the display section 473 to display a plurality of sets of screen data D as respective display screens P for being displayed on the display section 473, according to a display order stored together with the plurality of sets of screen data D in the screen data storage section 106.

The transmission control section 104 measures a time elapsed from a point of time when the display control section 103 has provided a transition from a display screen P displayed on the display section 473 to another display screen P, for example, by an internal timer of the control unit 10. Then, upon passage of a predetermined set time T1 since the above point of time, the transmission control section 104 provides transmission of, through the network interface section 91 to the external apparatus 20 (the external terminal), the set of screen data D stored in the screen data storage section 106 and representing the display screen P being displayed on the display section 473.

Furthermore, when the display control section 103 provides the transition from the display screen P being displayed on the display section 473 to the another display screen P, the transmission control section 104 provides transmission of, through the network interface section 91 to the external apparatus 20 (the external terminal), a set of screen data D representing the display screen P before the transition, even before the passage of the predetermined set time T1.

When the operation acceptance section 101 accepts a specification of an area E in the display screen P being displayed on the display section 473, the hiding section 105 hides the area E, for example, by manipulating screen data present within the area E. The operating section 47 acquires coordinates of two points where the user has touched on the display screen, for example, using a touch panel function provided in the display section 473, and accepts a rectangular area having a diagonal line formed of a line connecting between the two points as the above-mentioned area E to be subjected to hiding manipulation. The operating section 47 outputs to the operation acceptance section 101 a control signal indicating the area in the display screen identified by the above rectangular shape. Thus, the operation acceptance section 101 accepts the use's specification of the area E to be subjected to hiding manipulation.

The hiding section 105 performs the above hiding manipulation by masking the screen data present within the area E, for example, with data consisting of predetermined white pixels and/or black pixels.

The screen data storage section 106 stores a plurality of sets of screen data representing respective display screens to be displayed on the display section 473, together with a display order of the display screens, using an internal memory of the control unit 10 or other storages. Furthermore, the screen data storage section 106 stores (1) a set of screen data D representing a display screen P being displayed on the display section 473 and stores (2), when the display control section 103 has provided a transition from a display screen P being displayed on the display section 473 to another display screen P1, both of a set of screen data D representing the display screen P before the transition and a set of screen data D1 representing the display screen P1 after the transition.

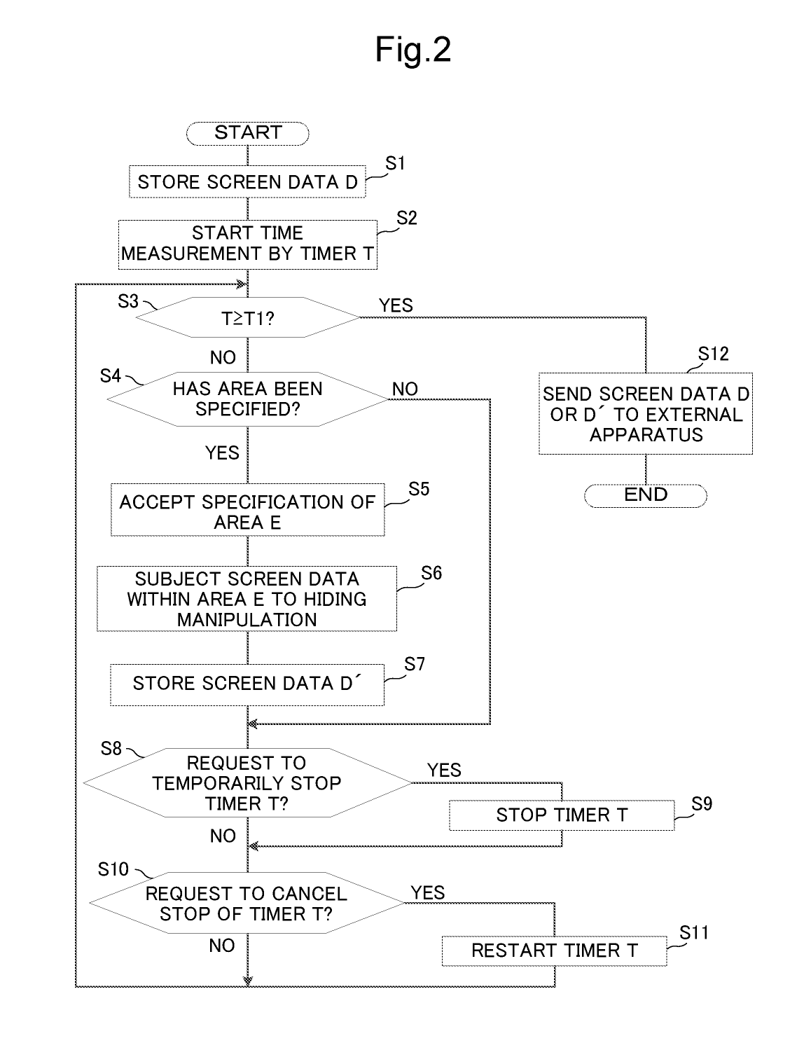

Next, a description will be given of processing for sending screen data performed by the image forming apparatus 1. FIG. 2 is a flowchart showing a first embodiment of processing for sending screen data performed by the image forming apparatus 1. This processing is performed, for example, when the operation acceptance section 101 has accepted, through the operating section 47, a request to provide a transition to a maintenance mode in which a display screen P is shared between the image forming apparatus 1 and the external apparatus 20 (for example, a personal computer in a maintenance company) and the control section 100 has provided a transition of the operation mode of the image forming apparatus 1 to the maintenance mode.

Suppose that in the maintenance mode the display control section 103 allows the display section 473 to display, according to an operation of the image forming apparatus 1, a display screen P for being displayed on the display section 473, the display screen P being stored in the screen data storage section 106. When in this state the display control section 103 provides a transition of the display screen P on the display section 473 to another display screen P1, the transmission control section 104 allows the screen data storage section 106 to store both a set of screen data D representing the display screen P before the transition and a set of screen data D1 representing the display screen P1 after the transition (S1), resets the timer T, and allows the timer T to start measuring the time elapsed from the point of time of the transition between the display screens (S2).

Subsequently, the transmission control section 104 determines whether or not the timer T has reached the predetermined set time T1 (for example, ten seconds) (S3). While the transmission control section 104 determines that the timer T has not reached the set time T1 (NO in S3), processing steps in S4 and later are performed.

In S4, the operation acceptance section 101 determines whether or not the user has specified, in the display screen P being displayed on the display section 473, an area E to be subjected to hiding manipulation (S4). The processing for accepting the user's specification of the area E in the display screen P is performed, for example, in such a manner that when the user touches the display screen P of the display section 473 with his/her finger and draws a circle or rectangle by a slide gesture on the display screen P, the locus of the slide gesture is detected by the touch panel function provided in the display section 473, and the area enclosed by the detected locus is accepted as the area E to be subjected to hiding manipulation by the operation acceptance section 101.

Furthermore, the set time T1 can be arbitrarily set by the user. For example, when the display control section 103 allows the display section 473 to display an entry screen for the set time T1 and the operation acceptance section 101 acquires information input through the entry screen by a user's operation of the operating section 47, for example, using the touch panel function, the transmission control section 104 holds the set time T1 based on the information acquired by the operation acceptance section 101. As just described, when the operation acceptance section 101 accepts a set time from the user, the transmission control section 103 holds and uses the set time as the predetermined set time T1. Therefore, in this embodiment, a set of screen data D representing a display screen P can be sent to the external apparatus 20 with the timing as desired by the user.

When the operation acceptance section 101 accepts the specification of the area E in the display screen P (YES in S4), the hiding section 105 identifies an area in the set of screen data D representing the display screen P being displayed on the display section 473 at this point of time, the area corresponding to the specified area E (S5) (hereinafter, the corresponding area is also referred to as the area E).

Furthermore, the hiding section 105 manipulates screen data present within the identified area E to hide the area E (S6) and allows the screen data storage section 106 to store, in place of the set of screen data D, a manipulated set of screen data D′ containing the screen data subjected to the hiding manipulation (S7). Examples of the hiding manipulation by the hiding section 105 include masking for replacing target data with a solid image consisting of predetermined white pixels and/or black pixels, tessellation, and so on.

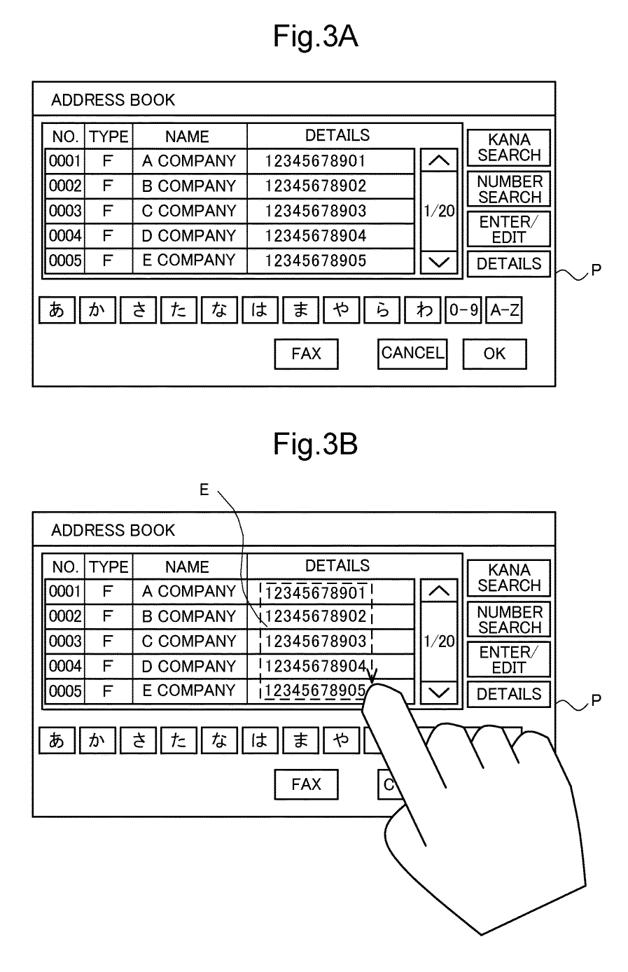

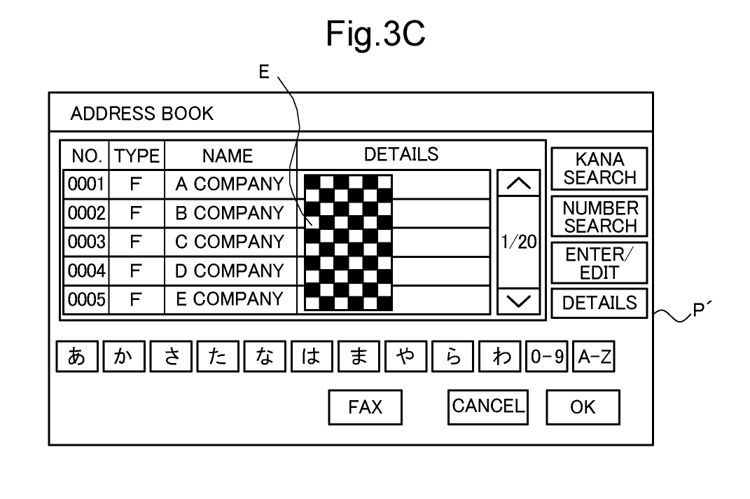

For example, when, in a display screen P (representing an “ADDRESS BOOK”) on the display section 473 shown in FIG. 3A, an area E is specified by the user as shown in FIG. 3B, a set of screen data D′ representing a display screen P′ where the area E is hidden is generated as shown in FIG. 3C.

On the other hand, when the operation acceptance section 101 has not accepted a specification of an area E in the display screen P being displayed on the display section 473 (NO in S4), the processing steps in S5 to S7 are skipped.

Subsequently, the operation acceptance section 101 determines whether or not a request to temporarily stop the timer T has been made by the user (S8). When the request to temporarily stop the timer T has been accepted (YES in S8), the transmission control section 104 stops the timer T (S9). An example of an operation for inputting a request to temporarily stop the timer T is a hold-down of the touch panel of the display section 473. On the other hand, when the operation acceptance section 101 has not accepted a request to temporarily stop the timer T (NO in S8), the processing step in S9 is not performed.

Subsequently, the operation acceptance section 101 determines whether or not a request to cancel the stop of the timer T has been made by the user (S10). When the request to cancel the stop of the timer T has been accepted (YES in S10), the transmission control section 104 restarts the timer T (S11) and the processing then goes back to S3. An example of an operation for inputting a request to cancel the stop of the timer T is a hold-down of the touch panel of the display section 473 during stop of the timer T. On the other hand, when the operation acceptance section 101 has not accepted a request to cancel the stop of the timer T (NO in S10), the processing step in S11 is not performed and the processing goes back to S3.

When in S3 the transmission control section 104 determines that the timer T has reached the set time T1 (YES in S3), the transmission control section 104 provides transmission of the set of screen data D′ stored in the screen data storage section 106 and corresponding to the display screen P′ through the network interface section 91 91 to the external apparatus 20 (S12). However, if the display screen P contains no area subjected to hiding manipulation when the transmission control section 104 determines that the timer T has reached the set time T1 (YES in S3), the transmission control section 104 provides transmission of the set of screen data D on the display screen P not subjected to hiding manipulation.

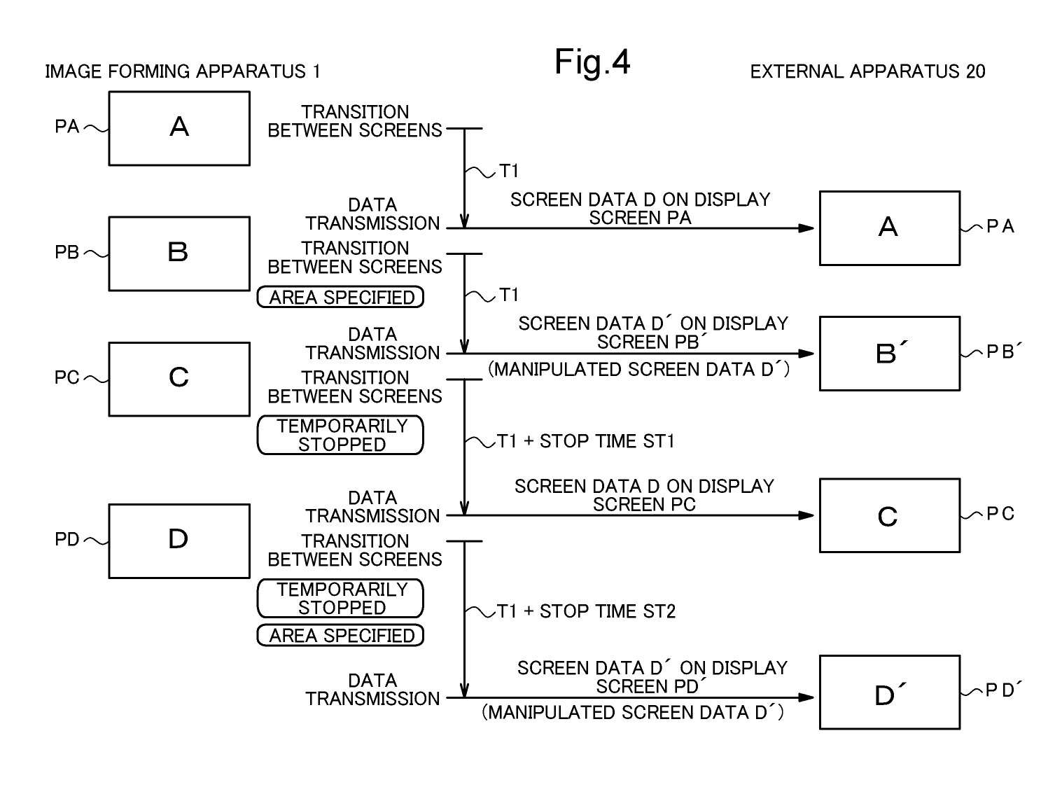

FIG. 4 is an explanatory diagram for illustrating a flow of transition between screens in the image forming apparatus 1 and a flow of transition between screens in the external apparatus 20. When a transition between screens has been made on the display section 473 of the image forming apparatus 1 to allow the display section 473 to display a display screen PA indicated by “A” and the set time T1 has passed since the transition, a set of screen data D on the display screen PA is sent to the external apparatus 20 and the display screen PA indicated by “A” is displayed on the external apparatus 20.

Subsequently, when a further transition between screens has been made on the display section 473 of the image forming apparatus 1 to allow the display section 473 to display a display screen PB indicated by “B” and an area E in the display screen PB has been specified before the set time T1 passes since the transition, a set of screen data D on the display screen PB is manipulated. Then, after the passage of the set time T1, the manipulated set of screen data D′ is sent to the external apparatus 20 and a display screen PB′ indicated by “B” is displayed on the external apparatus 20.

Furthermore, when a next transition between screens has been made on the display section 473 of the image forming apparatus 1 to allow the display section 473 to display a display screen PC indicated by “C”, a request to temporarily stop the timer T has been made before the set time T1 passes since the transition, and the timer T temporarily stops, a stop time ST1 is added to the set time T1. After the passage of the added time, a set of screen data D on the display screen PC is sent to the external apparatus 20 and the display screen PC indicated by “C” is displayed on the external apparatus 20. In other words, the external apparatus 20 continues to display the display screen PB′ indicated by “B” until the added time has passed.

Then, when a transition between screens has been made on the display section 473 of the image forming apparatus 1 to allow the display section 473 to display a display screen PD indicated by “D”, a request to temporarily stop the timer T has been made before the set time T1 passes since the transition, and an area E in the display screen PD has been specified before a time obtained by adding a stop time ST2 to the set time T1 passes, a set of screen data D on the display screen PD is subjected to hiding manipulation. Then, after the passage of the time obtained by adding the stop time ST2 to the set time T1, the manipulated set of screen data D′ is sent to the external apparatus 20 and a display screen PD′ indicated by “D” is displayed on the external apparatus 20.

According to the first embodiment, when the user specifies an area E in the display screen P (that he/she wants to conceal), screen data present within the specified area E is manipulated to hide the area E and a manipulated set of screen data D′ containing the screen data subjected to the hiding manipulation is sent to the external apparatus 20. Furthermore, a set of screen data D on the display screen P displayed on the display section 473 is sent to the external apparatus 20, not immediately after being displayed on the display section 473, but after the passage of the predetermined set time T1.

In a general display control apparatus (electronic apparatus), the user needs to previously set conditions of information to be hidden, which takes a lot of trouble and is therefore bothersome.

Unlike the above, according to this embodiment, if the user specifies an area E that he/she wants to conceal by the passage of the set time T1, confidential information can be hidden and a set of screen data having the confidential information hidden can be sent to the external terminal. Therefore, because there is no need for the user to take the trouble to previously set conditions of information to be hidden and the like, confidential information can be more easily hidden.

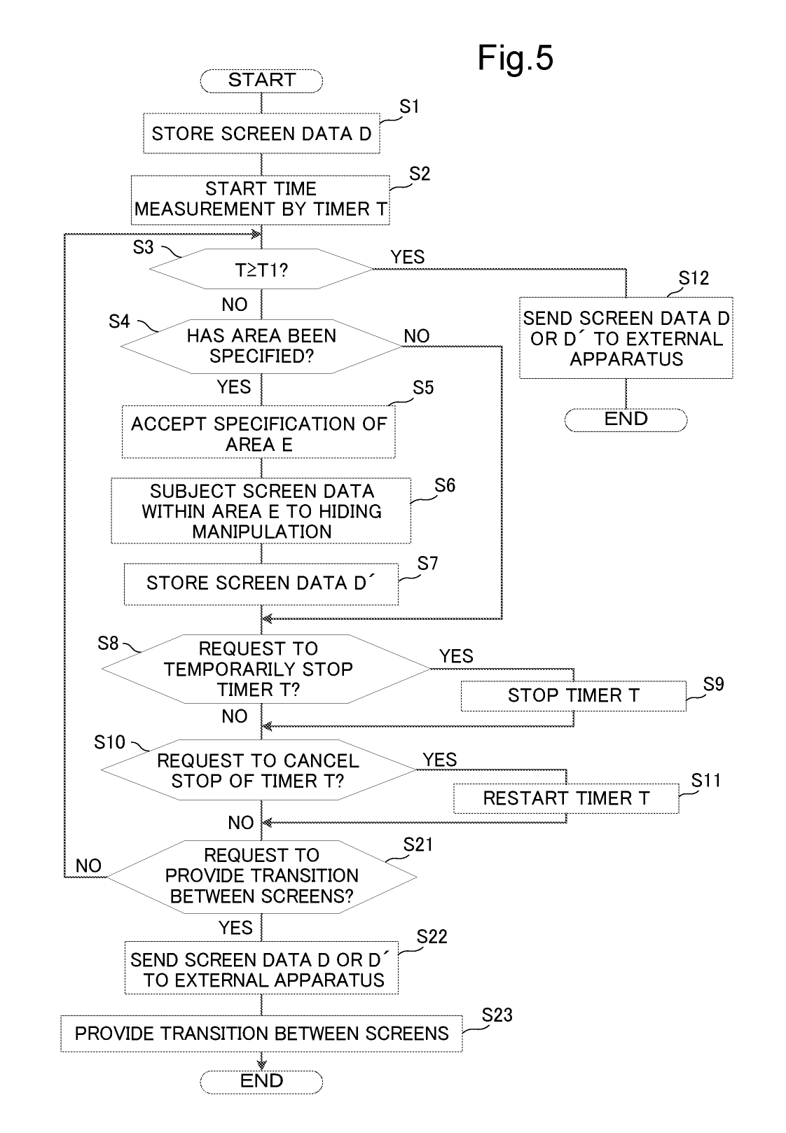

Next, a description will be given of a second embodiment of processing for sending screen data performed by the image forming apparatus 1. FIG. 5 is a flowchart showing the second embodiment of processing for sending screen data performed by the image forming apparatus 1. Further explanation of the same steps of processing as those in the first embodiment will be omitted.

The second embodiment is different from the first embodiment in that when a new transition between screens is made on the display section 473, the set of screen data D is sent to the external apparatus 20 without waiting for the passage of the set tome T1.

After the processing steps from S1 to S10 or S11 are performed like the first embodiment, the operation acceptance section 101 determines whether or not a new request to provide a transition between screens has been made by the user in S21. When here the operation acceptance section 101 accepts the request to provide a transition between screens based on a user's operation of the operating section 47 (YES in S21), the transmission control section 104 provides transmission of, through the network interface section 91 to the external apparatus 20, the set of screen data stored in the screen data storage section 106 and corresponding to the display screen P being displayed on the display section 473 at this point of time (i.e., the set of screen data on the display screen before the transition, but, if as for the set of screen data on the display screen before the transition an area E in the display screen has been hidden, the manipulated set of screen data D′ containing screen data subjected to hiding manipulation) (S22). Then, the display control section 103 provides the transition of the display screen on the display section 473 to the next display screen (S23). The processing steps in S22 and S23 may be performed in this or reverse order.

A user's new request to provide a transition between screens can be considered to be a user's indication of intention that the user has determined that the specification of an area to be subjected to hiding manipulation has been completed at this point of time or there is no need to specify an area to be hidden in the display screen P. Therefore, the set of screen data D is sent to the external apparatus 20 without waiting for the passage of the set time T1.

On the other hand, when the operation acceptance section 101 has not accepted a new request to provide a transition between screens (NO in S21), the processing goes back directly to S3.

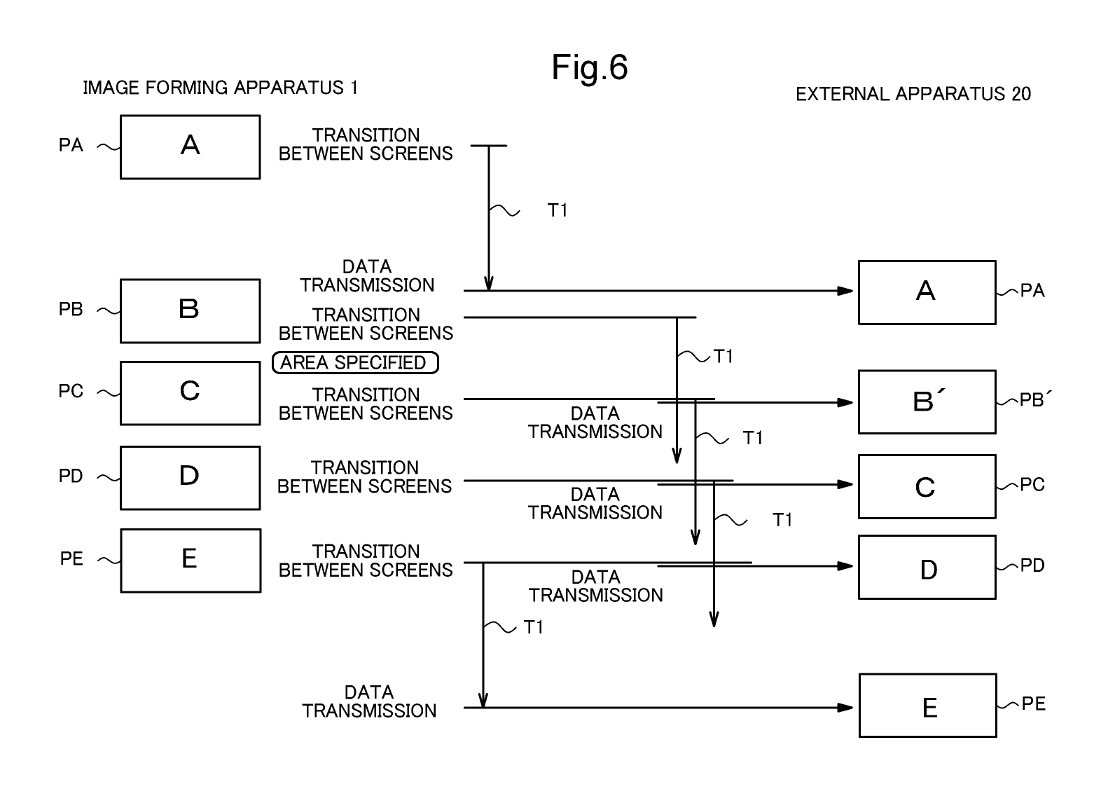

FIG. 6 is an explanatory diagram for illustrating a flow of transition between screens in the image forming apparatus 1 and a flow of transition between screens in the external apparatus 20. When a transition between screens has been made on the display section 473 of the image forming apparatus 1 to allow the display section 473 to display a display screen PA indicated by “A” and the set time T1 has passed since the transition, a set of screen data D on the display screen PA is sent to the external apparatus 20 and the display screen PA indicated by “A” is displayed on the external apparatus 20.

When a transition from the display screen PA indicated by “A” has been made on the display section 473 of the image forming apparatus 1 to allow the display section 473 to display new a display screen PB indicated by “B”, a set of screen data D on the display screen PB has been subjected to hiding manipulation before the set time T1 passes since the transition to the display screen PB, and a user's new request to provide a transition between screens has been accepted by the operation acceptance section 101, a manipulated set of screen data D′ obtained by subjecting the set of screen data D to hiding manipulation is sent to the external apparatus 20 without waiting for the passage of the set time T1 since the transition to the display screen PB, and a display screen PB′ indicated by “B” is displayed on the external apparatus 20. The display section 473 of the image forming apparatus 1 displays a display screen PC indicated by “C”.

Then, when, after the transition to the new display screen PC indicated by “C” has been made on the display section 473 of the image forming apparatus 1, a user's request to provide a transition between screens has been accepted by the operation acceptance section 101 before the set time T1 passes since the transition to the display screen PC, a set of screen data D on the display screen PC is sent to the external apparatus 20 without waiting for the passage of the set time T1 since the transition to the display screen PC and the display screen PC indicated by “C” is displayed on the external apparatus 20.

Likewise, also as for a set of screen data D on a display screen PD indicated by “D”, when a transition to the next display screen has been made according to a user's request to provide a transition between screens, the set of screen data D on the display screen PD indicated by “D” and displayed before the transition is sent to the external apparatus 20 even before the passage of the set time T1.

Furthermore, a set of screen data D on a display screen PE indicated by “E” and serving as a final page lastly displayed is sent to the external apparatus 20 after the passage of the set time T1.

According to the second embodiment, whenever a transition between screens has been made, a set of screen data D on the display screen before the transition is sent from the image forming apparatus 1 to the external apparatus 20 without waiting for the passage of the set time T1. Therefore, the occurrence of the situation where the display screen displayed on the image forming apparatus 1 is different from the display screen displayed on the external apparatus 20 can be avoided as much as possible. For example, in the first embodiment, the set of screen data D or the set of screen data D′ is not sent from the image forming apparatus 1 to the external apparatus 20 until the set time T1 passes since the transition between screens. Therefore, when transitions between screens have been made on the image forming apparatus 1 at short intervals, there may occur the situation where the display screen displayed on the display section 473 of the image forming apparatus 1 is different from the display screen displayed on the external apparatus 20. Unlike the first embodiment, according to the second embodiment, the occurrence of this situation can be avoided as much as possible.

The present disclosure is not limited to the configurations of the above embodiments and can be modified in various ways. Furthermore, although the description in the above embodiments has been given taking a multifunction peripheral as an example of the display control apparatus according to the present disclosure, the example is merely illustrative and the display control apparatus may be any other electronic apparatus, for example, a copier, a facsimile machine, a printer or other image forming apparatuses, or may be a personal computer, a mobile device or the like.

The structures and processing described in the above embodiments with reference to FIGS. 1 to 6 are merely illustrative of the present disclosure and the present disclosure is not intended to be limited to the above structures and processing.

Various modifications and alterations of this disclosure will be apparent to those skilled in the art without departing from the scope and spirit of this disclosure, and it should be understood that this disclosure is not limited to the illustrative embodiments set forth herein.

What is claimed is:

1. A display control apparatus comprising:
a display section;
an operation acceptance section that accepts a user's input of an operation;
a screen data storage section that stores a plurality of sets of screen data on respective display screens to be displayed on the display section;
a display control section that allows the display section to display the plurality of sets of screen data as the respective display screens, the plurality of sets of screen data being stored in the screen data storage section, while providing a transition from one of the display screens to another;
a hiding section that, when the operation acceptance section accepts a specification of an area in one of the display screens, manipulates the screen data present within the area to hide the area; and
a transmission control section that measures a time elapsed from a point of time when the display control section has provided the transition from the one display screen to the another, and, upon passage of a predetermined set time since the display control section has provided the transition from the one display screen to the another, provides transmission of the set of screen data or, when the hiding section has manipulated the screen data present within the area, the set of screen data containing the manipulated screen data to an external terminal.

2. The display control apparatus according to claim 1, wherein when the operation acceptance section accepts a request to stop measuring the time elapsed, the transmission control section stops measuring the time elapsed.

3. The display control apparatus according to claim 1, wherein when the display control section provides the transition from the one display screen displayed on the display section to the another display screen, the transmission control section provides transmission of the set of screen data on the one display screen before the transition to the external terminal even before the passage of the set time.

4. The display control apparatus according to claim 1, wherein when the operation acceptance section accepts a set time, the transmission control section uses the set time as the predetermined set time.

5. A non-transitory computer-readable recording medium with a data transmission program recorded thereon, the data transmission program allowing a computer to function as: an operation acceptance section that accepts a user's input of an operation;
a screen data storage section that stores a plurality of sets of screen data on respective display screens to be displayed on a display section;
a display control section that allows the display section to display the plurality of sets of screen data as the respective display screens, the plurality of sets of screen data being stored in the screen data storage section, while providing a transition from one of the display screens to another;
a hiding section that, when the operation acceptance section accepts a specification of an area in one of the display screens, manipulates the screen data present within the area to hide the area; and
a transmission control section that measures a time elapsed from a point of time when the display control section has provided the transition from the one display screen to the another, and, upon passage of a predetermined set time since the display control section has provided the transition from the one display screen to the another, provides transmission of the set of screen data or, when the hiding section has manipulated the screen data present within the area, the set of screen data containing the manipulated screen data to an external terminal.
